(19) United States
(12) Patent Application Publication
(10) Pub. No.: US 2003/0198790 A1
(43) Pub. Date: Oct. 23, 2003

(54) Window set and method for making a window set

(75) Inventors: Luc Bourassa, St-Majorique (CA); Michel Beaudoin, Drummondville (CA); Guy Moisan, St-Nicephore (CA)

Correspondence Address: MERCHANT & GOULD PC, P.O. BOX 2903, MINNEAPOLIS, MN, 55402-0903, US

(73) Assignee: CANIMEX INC., Drummondville (CA)

(21) Appl. No.: 10/418,437

(22) Filed: Apr. 16, 2003

(30) Foreign Application Priority Data
Apr. 18, 2002 (CA) 2,382,607

(51) Int. Cl. B32B 3/00

(52) U.S. Cl. 428/195.1

(57) ABSTRACT

According to the present invention, there is provided a window set comprising a plastic sheet having a first portion which is thermoformed, and a second portion provided with a silk-screen printed pattern. The window set comprises a support member for providing support to the plastic sheet. Both the plastic sheet and the support member are made of a material allowing a least partial transmission of light. The window set also comprises a securing means for securing the plastic sheet to the support member. There is also provided a method for making the window set of the present invention.

### FIELD OF THE INVENTION

The present invention relates to a window set and a method of making a window set.

### BACKGROUND

Stained glass is a very well known architectural and decorative element that has been used in window making for centuries. Genuine stained glass windows are of course very expensive because of the expert craftsmanship required for cutting, bevelling, assembling and setting the glass pieces in brass, copper or lead beading. Imitations of stained glass windows seek to reproduce the look of the genuine article at an affordable price.

Already known in the prior art is the look-alike glass that is basically a machined 1/4″ thick acrylic glass pain into which a decorative pattern has been grooved. A lead bead is placed manually into the bevelled grooves. This type of look-alike provides a good look, however the price remains a problem and thermal insulation is not possible.

Other look alike glasses are molded or thermoformed from 3/32″ to 1/8″ thick polycarbonate sheets which are then painted on the back side. Although less expensive, the resulting product is only an approximation of the shape and pattern of genuine stained glass and does not provide for the possibility of thermal insulation. By comparison, the acrylic look alike provides a clearer glass quality and a much better reproduction of genuine stained glass.

U.S. Pat. No. 5,631,057 (SUNDET) discloses an appliqué adapted to be adhered for decorative purposes to a plannar surface on a layer of transparent material such as glass or plastic. The appliqué comprises a player of polymeric material which is transparent and free of visible inclusions. The front surface of that layer includes a planar central portion having a decorative surface texture such as rippled, hammered, moss, Flemish, glue-chip, or baroque glass textures and beveled surface portions around that textures surface portion.

U.S. Pat. No. 5,558,827 (HOWES) discloses a decorative window having a simulated came structure. The simulated multipane window consists of a thick transparent plastic resin layer molded onto a sheet of glass.

U.S. Pat. No. 4,619,850 (CHARLTON) discloses a decorative glass window made of a glass sheet onto which a reticulated metal came network is bonded in order to simulate the look of stained glass and lead beading.

Also known in the prior art are U.S. Pat. No. 4,318,946 (PAVONE), U.S. Pat. No. 5,098,760 (FLETCHER), U.S. Pat. No. 5,989,666 (HADDEN), U.S. Pat. No. 5,840,391 (EICHHORN et al.), U.S. Pat. No. 5,853,852 (EICHHORN), and U.S. Pat. No. 6,372,075 (JOHNSON).

In view of the above, there is thus a need for imitations of stained glass windows that reproduce the look of the genuine article at an affordable price.

### SUMMARY OF THE INVENTION

An object of the present invention is to fulfill the above-mentioned needs.

According to the present invention, there is provided a window set comprising a plastic sheet having a first portion which is thermoformed, and a second portion provided with a silk-screen printed pattern. The window set comprises a support member for providing support to the plastic sheet. Both the plastic sheet and the support member are made of a material allowing a least partial transmission of light. The window set also comprises a securing means for securing the plastic sheet to the support member.

According to the present invention, there is provided a method for making a window set comprising the steps of a) thermoforming a first portion of a plastic sheet; b) silk-screen printing a pattern on a second portion of the plastic sheet; and c) securing the plastic sheet as treated in steps a) and b) together with a support member.

### BRIEF DESCRIPTION OF THE FIGURES

FIG. 1 shows a perspective view of an embodiement of a window set of the present invention, in relation to a frame.

FIG. 2 shows a partial transversal cross sectional view along line V-V of the window set shown in FIG. 1.

FIG. 3 shows a perspective exploded view of two elements of the window set shown in FIGS. 1 and 2.

FIG. 4 shows a schematic partial perspective view of an element of the window set in relation to the hands of a craftsman.

FIG. 5 shows a top view slightly in perspective of one of the elements shown in FIG. 2.

FIG. 6 shows a perspective exploded view of the two elements of FIG. 3, before assembly of said elements.

FIG. 7 shows a schematic partial perspective view of the two elements of the window set shown in FIG. 6, in relation to the hands of a craftsman.

FIG. 8 shows a perspective view of the window set of FIG. 1, in an assembled position.

FIG. 9 shows a perspective view of the window set shown in FIG. 2, with its protective plastic film partially peeled.

FIG. 10 shows a perspective view of the window set and frame of FIG. 1, in an assembled position.

### DESCRIPTION OF A PREFERRED EMBODIMENT OF THE INVENTION

According to the present invention there is provided a two-pieced window set assembly that captures the look of real stained glass but is much less expensive to produce than the previously known look alike glasses. The window set of the invention may be used for installation in frames, doors, walls or garage doors.

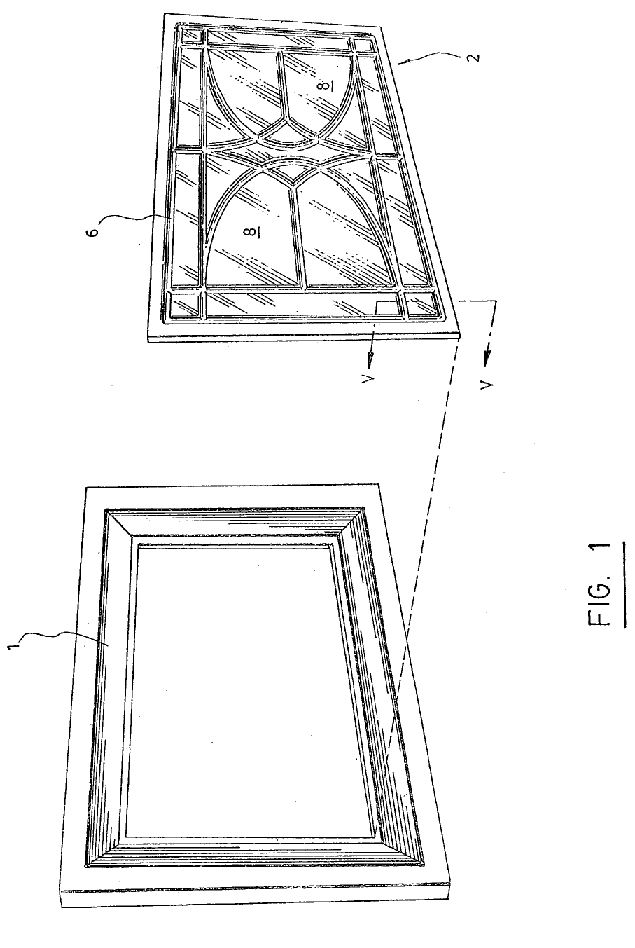

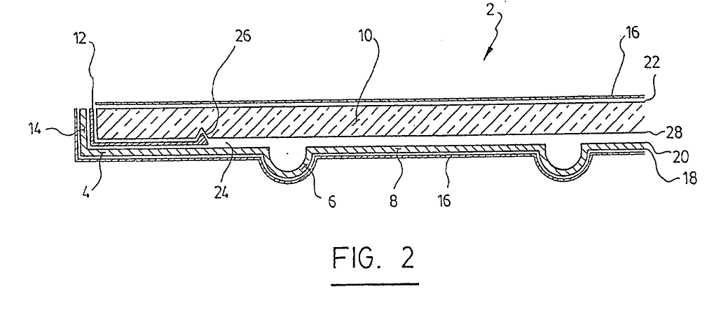

Now referring to FIGS. 1 and 2, there is shown a window set (2) comprising a plastic sheet (4) having a first portion which is thermoformed (6), and a second portion provided with a silk-screen printed pattern (8). The window set (2) also comprises a support member (10) for providing support to the plastic sheet (4). The plastic sheet (4) and the support member (10) are made of a material allowing a least partial transmission of light. The window set also comprises a securing means which is preferably an adhesive material (12) such as a liquid adhesive, sealant or glue, for securing the plastic sheet (4) to the support member (10).

The plastic sheet (4), also referred to herein as the <<decorative front piece>>, has a portion which is thermoformed (6), and another portion provided with a silkscreen printed pattern (8). This part of the window set (2) provides the decorative or aesthetic feature of the bevelite look-alike or stained-glass look.

Preferably, as will be described in further detail hereinbelow, in order to decorate the glass and to make it look as realistic as possible, a silk screen pattern is printed onto the very thin plastic sheet (4), and the silk screen printed sheet is then thermoformed to the desired pattern with all the details of bevels and beading needed to provide a realistic stained-glass look. The thinness of the plastic sheet (4) imparts not only a clear glass quality look but also allows for great accuracy in the thermoforming molding (6) yielding better imitations of textured glass and lead beading. The combination of silk screen printing and thermoforming a very thin plastic sheet (4) is therefore preferable to the window set (2) of the invention in order to obtain the look of genuine stained glass.

The window set (2) comprises a support member (10), or what will be also be referred to herein as a <<backing>>. This element provides the window set (2) with the necessary support and rigidity expected from a window. As will also be explained in further detail hereinbelow, the support element (10) or backing is preferable when the thermoformed plastic sheet (4) or decorative front piece is very thin to suit the aesthetic requirements. Such thin plastic sheet (4) is not designed to provide the adequate support and rigidity needed of a window.

Both the plastic sheet and the support member are made of material allowing a least partial transmission of light, since light transmission is usually an implicit feature for a window.

As mentioned hereinabove, the material of the decorative front piece (4) and the material of the backing (10) may be one and the same material. For instance, the plastic sheet (4) and the support member (10) may both be made of polyvinyl chloride (PVC). In order to arrive at the present invention, the material for the decorative front piece (4) must allow thermoforming to the desired relative thickness disclosed hereinbelow. The material for the backing (10) must in turn ensure the adequate rigidity and support expected from a window set (2). Alternately, they may be made of the same material. Once the window set (2) is completed, it can be inserted in a frame (1).

Referring in particular to FIG. 2, the adhesive material (12) is capable of securing together the materials of the decorative front piece (4) and the support member (10). Therefore any adhesive material susceptible of making such materials adhere to one another will fulfill the purpose of the present invention. As an example, when the decorative front piece (4) and the backing (10) are made of polyvinyl chloride (PVC), the securing means (12) may be a glue made of methylene chloride.

Preferably, the plastic sheet (4) has a bordered edge (14) which is folded for surrounding a peripheral edge of the support element (10). The bordered edge (14) is a convenient and user friendly feature which basically allows for easier assembly of the window set (2) and a high quality finish thereof. Indeed, the folded edge (14) allows for a tailored fit of the support member (10) within the decorative front piece (4). Tightly and snuggly encasing and holding the support member (10) within the decorative front piece (4) in turn facilitates the application of the adhesive material (12) along the edges of both elements (4) and (10). The securing together of both elements (4) and (10) of the window set (2) assembly will be explained in greater detail hereinbelow.

Refering now to FIG. 1, preferably, the first portion (6) which is thermoformed and the second portion (8) which is silk screen printed overlap at least partially. More preferably, the first and second portions (6, 8) may be the same portions. The combination of the thermoforming, the silkscreen printing and the thinness of the plastic sheet (4) conveys a realistic stained-glass look which is difficult to distinguish from the genuine article.

Preferably, any material that can be thermoformed to an approximate thickness of 0.023 inch may be used for making the plastic sheet (4) or decorative front piece of the invention. The thickness of the support member (10) or backing is ideally approximately 0.093 inch. The thickness allowance for the adhesive material (12) is approximately 0.009 inch. Therefore, the total thickness of the assembled and secured window set (2), including the plastic sheet (4), support member (10) and the adhesive material (12) should be approximately 1/8 of an inch or in between 0.125 to 0.135 inch thick. More preferably still, the thermoformed plastic sheet (4) is between 0.010 inch and 0.065 inch thick. It should be understood that these measurements are purely indicative and are not meant to restrict the scope of the invention. Therefore, a window set (2) falling outside of these measurements is not to be understood as falling beyond the scope of the present invention.

According to another preferred aspect of the invention, the support member (10) is transparent. Preferably, the support member (10) is made of a plastic material, such as PVC. More preferably, the support member is a plastic plate. More preferably still, the plastic plate is about 0.093 inch thick.

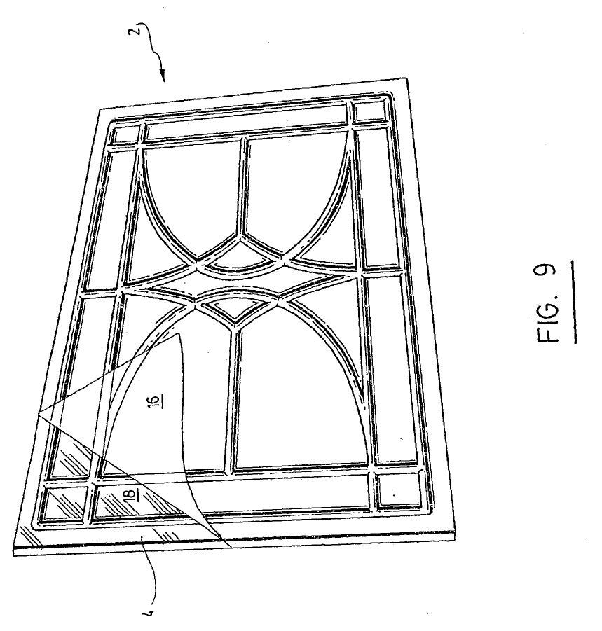

Refering now to FIGS. 2 and 9, preferably, the window set (2) also comprises a removable plastic film (16) covering at least partially an exposed face (18) of the plastic sheet (4). More preferably, such a plastic film normally protects both faces of the plastic sheet (4) to be thermoformed. The plastic film (16) serves a protective purpose intended to both facilitate handling, assembly and prevent scratching and/or soiling of the surface covered therewith. Obviously, and as will be further described herein below, the film on the silk screen printed and thermoformed face (20) must to be peeled away and removed prior to silk screen printing and or thermoforming. However, the film (16) on the opposite exposed face (18) may remain in place up until actual assembly into a frame for instance.

Refering again to FIG. 2, preferably, the window set (2) also comprises a removable plastic film (16) covering at least partially an exposed face (22) of the support member (10). Here again, the plastic film (16) serves a protective purpose which, as already explained herein, facilitates handling, assembly and prevents scratching and/or soiling of the surface covered therewith.

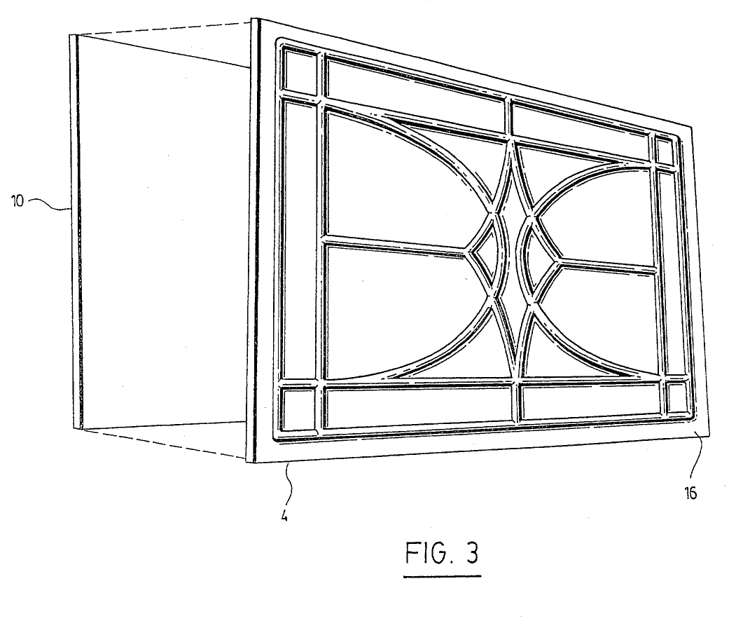

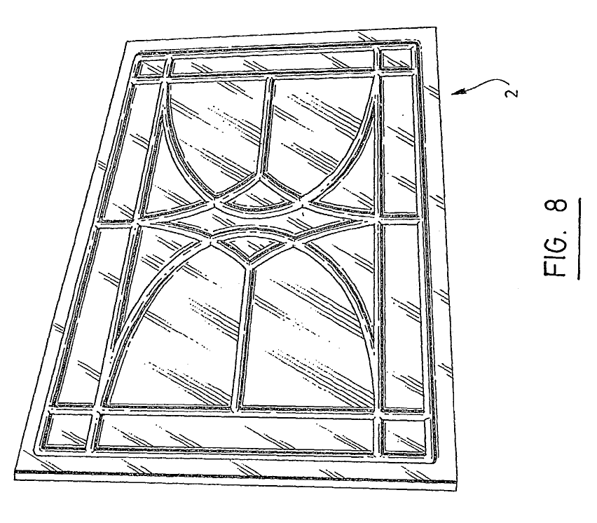

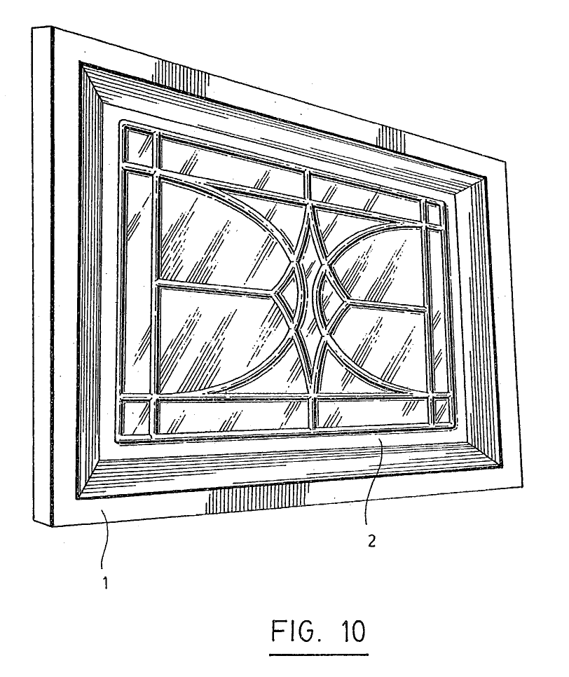

Now referring to FIGS. 1 through 10, there is also provided a method for making a window set (2) comprising the steps of a) thermoforming a first portion (6) of a plastic sheet (4); b) silk-screen printing a pattern on a second portion (8) of the plastic sheet (4); and c) securing the plastic sheet (4) as treated in steps a) and b) together with a support member (10).

Preferably, the first and second portions (6,8) of the plastic sheet (4) overlap at least partially. When they do, the step b) of printing is performed before the step a) of thermoforming.

Preferably, the first and second portions (6, 8) of the plastic sheet (4) are the same. In this case, step b) is performed before the step a).

Referring again to FIG. 2, the protective plastic film (16) is removed from the surface to be silk screen printed and/or thermoformed prior to silk screen printing and or thermoforming. Preferably, the silk screen pattern is first printed onto a thin plastic sheet (4) or the decorative front piece. Then, the plastic sheet (4) is thermoformed to the desired pattern to provide the reproduction glass, with all of the bevels and beads needed for a realistic stained glass look. The thinness of the plastic sheet (4) allows for a clear glass. Clear glass quality is an advantageous feature of the invention. Imparting a clear glass quality is preferable in order to achieve a look that is difficult to distinguish from real stained glass. The thinness of the plastic sheet (4) is also preferable in order to accomodate thermoforming and molding of intricate and delicate patterns and designs which are a typical feature of genuine stained glass windows. Therefore, a very thin plastic sheet (4) will enable the accuracy needed to convey the look of handcrafted lead beading in the molding. The thinness of the plastic sheet (4) is thus preferable to obtaining both the clear glass quality and the bevelite look.

Producing a glass out of a thin plastic sheet material obviously provides a very flexible glass. The thermoformed glass piece alone is not rigid enough to act as a regular window because of its relative thinness. It is also much too thin to be installed directly as a glass in a window frame. Therefore, in order to provide the required solidity and rigidity to the window set (2), a support member (10) or backing is assembled behind the thermoformed decorative front piece (4) as shown in FIGS. 2, 3 and 6.

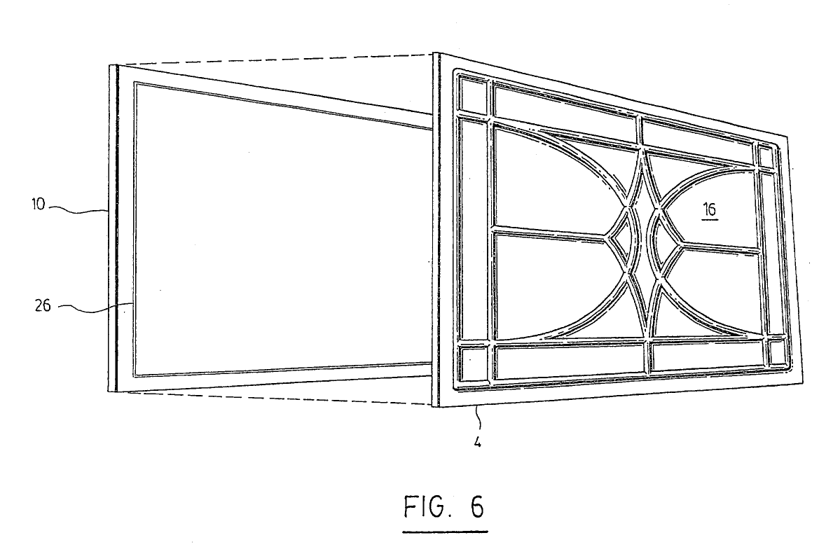

Refering now to FIGS. 2 and 6, in order to assemble both elements (4) and (10) of the window set (2), the backing (10) is set inside the decorative front piece (4).

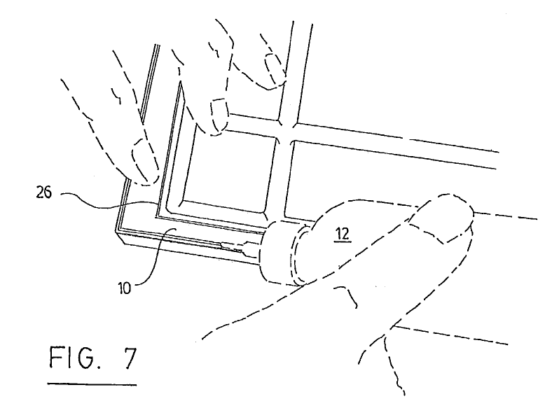

Refering now to FIGS. 2 and 7, preferably, the folded surrounding edge (14) serves to hold or encase the backing (10) within the decorative front piece (4) while the adhesive material (12) is applied. The space (24) in between both elements (4) and (10) once juxtaposed against each other receives the adhesive material (12). The adhesive material (12) is applied within that space (24) in between the decorative front piece (4) and the backing (10) in order to permanently secure both elements (4) and (10) together.

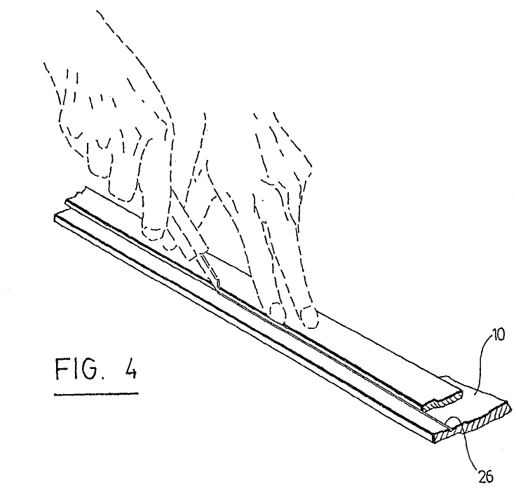

Refering now to FIGS. 2, 4 and 5, preferably, the method preferably comprises in step c) making of a groove (26) along the periphery of the internal face (28) of the support member (10). Any tool suitable for grooving, such as a chisel or knife, may be used in order to make the necessary groove (26) along the periphery of the support member (10), as shown in FIG. 4.

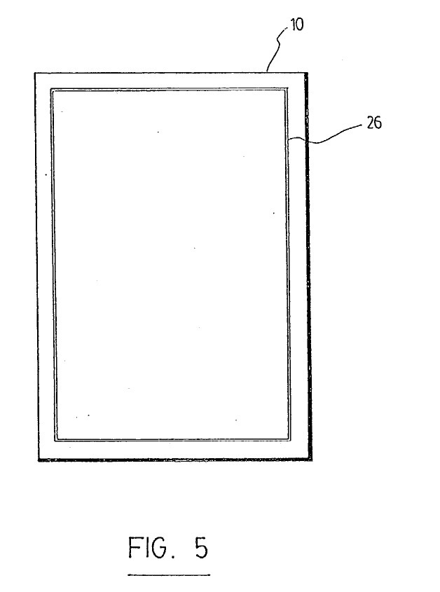

Refering back to FIGS. 2 and 5, once the groove (26) is made, both elements (4) and (10) are assembled with internal faces (20) and (28) juxtaposed to each other.

Refering now to FIGS. 5 and 7, the adhesive material (12) is applied within the space (24). The adhesive material (12) is applied all around the periphery of the assembly and inside the space (24) created in between the adjacent juxtaposed faces (20) and (28) of the decorative plastic sheet (4) and the support member (10). In doing so, the adhesive material (12) will spread by capillarity until it reaches the groove (26) were it will settle and stop spreading. The groove (26) therefore serves the purpose of containing the adhesive material (12) and preventing its unwanted spreading. Also, in an alternative embodiment, a strip of glue is applied to one of the plastic sheet (4) and support member (10), then the plastic sheet (4) and support member (10) are pressed together.

Although the present invention has been explained hereinabove by way of a preferred embodiment thereof, it should be pointed out that any modifications to this preferred embodiment within the scope of the appended claims is not deemed to alter or change the nature and scope of the present invention.

What is claimed is:

1. A window set comprising:
a plastic sheet having a first portion which is thermoformed, and a second portion provided with a silk-screen printed pattern;
a support member for providing support to the plastic sheet, the plastic sheet and the support member being made of a material allowing a least partial transmission of light; and
securing means for securing the plastic sheet to the support member.

2. The window set of claim 1, wherein the plastic sheet has a bordered edge which is folded for surrounding a peripheral edge of the support member.

3. The window set of claim 1, wherein the first and second portions overlap at least partially.

4. The window set of claim 3, wherein the first and second portions are the same portions.

5. The window set of claim 1, wherein the plastic sheet is between 0.010 inch and 0.065 inch thick.

6. The window set of claim 1, wherein the support member is transparent.

7. The window set of claim 1, wherein the support member is made of a plastic material.

8. The window set of claim 7, wherein the support member is a plastic plate.

9. The window set of claim 1, wherein the securing means is an adhesive material.

10. The window set of claim 1, further comprising a removable plastic film covering at least partially an exposed face of the plastic sheet.

11. The window set of claim 1, further comprising a removable plastic film covering at least partially an exposed face of the support member.

12. The window set of claim 2, wherein the plastic sheet is between 0.010 inch and 0.065 inch thick.

13. The window set of claim 4, wherein the plastic sheet is between 0.010 inch and 0.065 inch thick.

14. The window set of claim 2, wherein the support member is transparent.

15. The window set of claim 4, wherein the support member is transparent.

16. The window set of claim 5, wherein the support member is transparent.

17. A method for making a window set comprising the steps of:
a) thermoforming a first portion of a plastic sheet;
b) silk-screen printing a pattern on a second portion of the plastic sheet;
a) securing the plastic sheet as treated in steps a) and b) together with a support member.

18. The method of claim 17, wherein the first and second portions overlap at least partially, and step b) is performed before step a).

19. The method of claim 18, wherein the first and second portions are the same, and step b) is performed before step a).

20. The method of claim 17, wherein step c) further comprises making a groove along a periphery of a face of the support member, and subsequently applying a liquid adhesive between the said face of the plastic sheet and the support member.
